(19) United States
(12) Patent Application Publication
(10) Pub. No.: US 2003/0041329 A1
(43) Pub. Date: Feb. 27, 2003

(54) Automobile camera system

(76) Inventor: Kevin Bassett, Cedar Rapids, IA (US)

Correspondence Address: Richard C. Litman, LITMAN LAW OFFICES, LTD., P.O. Box 15035, Arlington, VA, 22215, US

(21) Appl. No.: 09/935,713

(22) Filed: Aug. 24, 2001

(51) Int. Cl. H04N 7/173; H04N 7/18

(52) U.S. Cl. 725/105; 348/148; 348/152

(57) ABSTRACT

An automobile camera system which employs a detection and imaging system, including a force and motion detector sensor system, a wireless Internet network interface, and a digital/web camera network for capturing video and related audio data. The system is configured for vehicles to capture image data of intruders within and outside a vehicle. The system operates in different modes, which includes a snapshot by motion mode, a snapshot by force mode, and a video by force mode. Data captured in these respective modes are transmitted wireless to a lap-top or desk-top computer configured with an e-mail software system which automatically transmits captured data to selective e-mail sources over the Internet. Each sensor is electrically linked to the camera network to activate camera modes based on intruder activity. Image data capture includes satellite transmission links for computer based image retrieval and/or vehicle surveillance.

### BACKGROUND OF THE INVENTION

1. Field of the Invention

The present invention relates generally to intruder alert systems and, more specifically, to a detection and imaging system for vehicles which captures real-time images of an intruder or vandal, and automatically transmits images to selective remote locations via the Internet.

2. Description of the Related Art

Numerous camera systems have been devised for deployment in vehicles to obtain pertinent data from various simulated accident scenarios or tests. It has been the practice to mount cameras on test vehicles in such a manner as to record on film the actions and/or reactions of drivers under crash or impact circumstances, and/or monitor the instrument panel for clues as to possible instrument related or mechanical failures. However, there has been an increase in automobile vandalism and automobile theft by “car jacking.” It has become increasingly difficult to track this criminal activity. While the normally reported data such as license plate numbers, VIN numbers etc. are easily obtained, the more critical data such as a positive identification or physical evidence of the perpetrator(s) is not as easily acquired. Thus, to solve this problem, the automobile camera system as herein described is selectively activated within a vehicle to monitor activity of intruders and/or vandals, as a new use of conventional camera systems. In this regard, data in the form of digital images are automatically made and transmitted to remote sites such as insurance agencies, police stations, etc. and/or the owner via a personal digital assistant (PDA). Further, special motion and/or impact sensors are used to activate the camera system and obtain images of the activity of an intruder in real-time.

U.S. Pat. No. 3,515,472 issued to Schwitzgebel discloses a vehicle camera system having a motion picture camera mounted to a central portion of the steering column, beneath the dashboard. This camera mounting arrangement serves to protect the camera against shock, fire, and missile hazards. The camera includes a pneumatic bulb fixed to a bracket connected to the steering column sleeve. A compression band interconnects the bulb and pivotally mounted brake lever which supports a brake pedal. When the brake pedal is depressed by an operator, the band is activated which compresses the bulb via a pneumatic switch.

U.S. Pat. No. 4,815,757 issued to Hamilton discloses a rapid development surveillance vehicle for detecting illegal immigration across national borders. An off-road vehicle is equipped with a rapid mast erection/retraction assembly which includes a carriage mechanism with a telescoping mast. A track connector system slidably carries the carriage mechanism via a pivoting support arm Ram air cylinders move the carriage mechanism in translation and rotational movement as guided on the track system in a manner that the mast is moved from a stowed horizontal position to an erect vertical position. During deployment of the mast, a longitudinal roof is opened automatically and a levelling system is activated to ensure the vehicle is within on degree of level. Level sensors and pressure sensors ensure that the vehicle is level prior to the deployment of the mast.

U.S. Pat. No. 5,001,558 issued to Burley et al. discloses a vehicle equipped with a night vision enhancement system. The system includes an infrared imaging device and a visible light color camera which are configured to synoptically view a scene, that is, to view the same scene from the same point of view to prevent the effect of parallax. A mirror transparent to infrared is used to selectively pass infrared light to the infrared camera, and reflect visible light to the color camera. The cameras and mirror are located in a position within the vehicle affording a forward view of the environment.

Other vehicle mounted camera features are described in the patents granted to Akaha (JP 58 78154), Koiwai (JP 2 300715) and Nishida (JP 5 150314). In the patent granted to Akaha, the key feature is to make snapshooting from a car easy and exact during driving. The camera including a viewing screen is mounted in a window box which attaches to a universal handle for manipulation. The handle is disposed within a central portion of the dashboard of a vehicle. In the Japanese Patent granted to Koiwai a similar box covered camera is described mounted to a vehicle, except that a heater mechanism is disposed within the camera box to remove or melt ice, snow, etc. from the cover glass of the box or adjacent camera lens.

The patent to Nishida discloses a vehicle equipped with cameras mounted in the hood and trunk sections of a vehicle. Each camera monitors activity in the front, side and rear of the vehicle respectively during travel. When a predetermined acceleration threshold has been reached, the camera system provides continuous monitoring for a predetermined time. A set of sensors are mounted on the vehicle to monitor the acceleration of adjacent or surrounding vehicles. When the detected value of the acceleration exceeds the threshold value, a CPU determines a collision state for which photographs are continuously made.

U.S. Pat. Nos. issued to Kivolowitz (5,881,321), Bamford (5,596,382) and Wada et al. (5,523,811) disclose motion and impact activated camera systems for vehicle mounting. Inertial sensors are incorporated within the structure of the camera taught by the patent of Kivolowitz. The sensors detect camera movement along three orthogonal axes as well as angular rotation about three axes. Linear and angular acceleration detected by the sensors is transmitted from respective axial locations to a remote site by wireless communication.

U.S. Pat. No. 5,596,382 issued to Bamford discloses an impact camera triggering device which is used in combination with a camera. The device includes an impact activate triggering mechanism which responds to inertial from any horizontal direction. Upon sudden impact or deceleration an enclosed inertia member moves relative to the camera which causes the releases of a spring which directly or indirectly actuates the shutter on the camera.

U.S. Pat. No. 5,523,811 issued to Wada et al. discloses a camera device mounted within a side rear-view mirror. The rearview mirror comprises a half-mirror which reflects light from a vehicle visible to the occupant or driver. A lens is disposed adjacent to the half-mirror and receives light passing through the half mirror. An image pick-up device is optically coupled to the lens and receives light passing therethrough to form an image signal corresponding to the received light. The image signal is photoelectrically converted into an electrical signal which is input to a camera signal processing circuit. The final processed image is visualized on a monitor arranged in a passenger area which serves to expand the operator's and/or passenger's field of vision to the sides and rear of the vehicle.

Camera systems with image processing units are commercially available in various varieties. The following patents to Schmidt (U.S. Pat. No. 5,793,420), Yuge et al. (U.S. Pat. No. 5,805,209), Takahashi et al. (U.S. Pat. No. 5,768,640), Nobuoko (U.S. Pat. No. 6,198,504 B1) Miyagawa (JP 61 159630) illustrate variations of these types of systems which include recording features. of particular note, the U.S. Pat. No. 5,793,420 issued to Schmidt discloses a vehicle video system which includes at least three video cameras electrically connected to a video signal relay device which directs video signals generated by each of the respective cameras. Each camera is externally mounted to the vehicle and is automatically triggered to commence recording upon activation of a turn signal of the vehicle on which the system is deployed.

Other techniques which employ input of image data from cameras or the like for subsequent data transmission are disclosed in the patents to Shiota et al. (U.S. Pat. No. 6,185,000 E1), Izumi et al. (U.S. Pat. No. 6,195,642), Schneck et al. (U.S. Pat. No. 6,195,666 E1), Palmer et al. (U.S. Pat. No. 6,195,683 B1), Suzukawa et al. (U.S. Pat. No. 6,198,510 B1), Chen et al. (U.S. Pat. No. 6,199,106), Shaw et al. (U.S. Pat. No. 6,199,106 B1) and Aral (EP 0 889 635 A2).

U.S. Pat. No. 6,185,000 B1 issued to Shiota et al. discloses an digital image processing technique which records an image from a digital camera for inputting data in the form of instructions thereon. Dates, titles and other information are transferred to the image for subsequent printing or viewing.

U.S. Pat. No. 6,195,530 B1 issued to Smith et al. discloses a selective messaging display feature via an interactive terminal comprising a processor, a local data store, a character generator, a key pad or remote control for inputting information to the processor. Screen commands are stored at the terminal and are used to acquire or download screens which may include image data from a central database. U.S. Pat. No. 6,195,642 issued to Izumi et al. discloses a multimedia receiving device which receives and transmits audio and video data from a broadcast satellite to a remote unit via wireless transmissions.

U.S. Pat. No. 6,195,683 B1 issued to Palmer et al. discloses a digital image data processing scheme which employs a video frame grabber for transmitting video images to a remote location for video conferencing. The apparatus provides audio and video data across a network of one or more workstations. The network also includes a receiver for the local workstations to receive both audio and video data from the remote workstations. The data is sent and received over a variable bandwidth digital data connection between the respective remote workstations. The U.S. Pat. No. 6,198,510 issued to Suzukawa et al. discloses an Internet displaying apparatus which utilizes a television terminal to access and transmit Internet related video and audio signals thereto and therefrom.

U.S. Pat. No. 6,199,106 B1 issued to Shaw et al. discloses an electronic mail system with advertising which provides scheduled messages to a remote user in a batch oriented system. A user creates and/or reads electronic mail locally. While in use, a message is displayed to the user on a portion of the local monitory in a scheduled sequence. The message is targeted to the particular user. When the user transmits e-mail created and/or received, the user's local client establishes a connection via modem with a remote e-mail service center. The remote e-mail server system receives the e-mail transmitted by the user and updates the user's local messages in accordance with a distribution schedule.

The European Patent granted to Arai (EP 0 889 635 A2) discloses a digital camera which stores captured picture data and e-mail address data inputted from a key entry unit in a flash memory, so that they are associated with each other and then transfers the picture data and the e-mail address data to a personal computer via an I/O port or an infrared communication unit. The received picture data is then transmitted to a destination terminal on a computer network on the basis of the received e-mail address data.

Another class of camera is the camera system disclosed in the U.S. Pat. No. 5,913,078 issued too Kimura et al. which utilizes a satellite position system for receiving/transmitting an electric wave of data including position information from the global positioning system and for recording a photographing position together with a photograph image. The photographing attitude of the camera is arbitrarily changed in accordance with an image to be photographed. The camera is configured with an antenna which enables electric wave data reception regardless of the attitude of the camera.

U.S. Pat. No. 5,815,093 issued to Kikinis discloses a vehicle accident recording system which employs a digital camera connected to a controller, a non-volatile memory, and an accident sensing interrupter. The controller accesses images from the digital camera periodically and stores the images in a limited space of memory sectors. The result is a recorded history of images spanning a time period up to the incidence of an accident of the number of images stored times the average time period between images. The images are accessible for downloading to a digital device, including positional data which is also recorded and accessed via a global positioning satellite (GPS) receiver. A similar GPS receiver is used in the camera systems of the following patents respectively issued and granted to Imoto (U.S. Pat. No. 6,160,964) and Taniguchi (JP 4 70724).

U.S. Pat. No. 6,008,841 issued to Charlson discloses a vehicle surveillance camera system actuated upon passenger entry. A plurality of cameras are mounted within the internal compartment and exteriorly of the vehicle or bus with one camera observing directly the area of the door. The output signals of all cameras are supplied through a multiplexer which causes all the output signals of the cameras to be placed on a single frame of the video camera permitting simultaneous observance of all cameras when the recorded film is observed by an operator.

U.S. Pat. No. 5,726,660 issued to Purdy et al. discloses a personal data unit (PDU) which is operable to collect video information via a camera and audio information via a microphone. The PDU utilizes a cellular link for transmission of the collected information to a central station. Position and time information is received from the GPS via an antenna mounted to the PDU as portable unit.

Other patents issued to Wright et al. (U.S. Pat. No. 6,198,927 B1), Huckins (U.S. Patent Des. 388,107) and Auty et al. (U.S. Pat. No. 5,809,161) disclose conventional system features and/or ornamental features of vehicle mounted monitoring systems which are considered to be of general relevance to the automobile camera system as herein described.

None of the above inventions and patents, taken either singularly or in combination, is seen to describe the instant invention as claimed. Thus, an automobile camera system solving the aforementioned problems is desired.

### SUMMARY OF THE INVENTION

The invention is an automobile camera system made up of a detection and imaging system having a force and motion detector sensor system, an internet network connection, and a digital/web camera which captures video images for wireless transmission. The system is particularly configured for vehicles to capture image data of intruders within and outside a vehicle, but can be used to detect the same in homes, work spaces, and other areas. The system operates in different modes, which includes a snapshot by motion mode, a snapshot by force mode, and a video by force mode. Data captured in these respective modes are transmitted to a lap-top or desk-top computer configured with an e-mail system which automatically transmits captured data over the Internet to selective e-mail addresses.

A plurality of digital cameras are mounted within the cab portion of a vehicle, with electrical power connections configured through the dome-light of the vehicle. A series of motion and/or impact sensors are also mounted within various body compartments to detect or sense activity of an intruder. The sensors are electrically linked to the camera network to activate camera modes based on intruder activity. Images are captured within a 360 degree field of view, and captured at a rate of 2-4 color images per second. The system also includes a satellite link for computer based image retrieval and/or vehicle tracking or surveillance.

Accordingly, it is a principal object of the invention to provide an automobile camera system which captures real-time images of intruders or vandals.

It is another object of the invention to provide an automobile camera system which automatically transmits captured real-time images to remote sites via the internet.

It is a further object of the invention to provide an automobile camera system which automatically transmits captured real-time data via e-mail.

Still another object of the invention is to provide an automobile camera system which automatically transmits via e-mail captured real-time data which is accessible by hand held personal digital assistants PDAs or the like.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of an automobile camera system according to the present invention.

FIG. 2 is a perspective view of an automobile configured with the automobile camera system.

FIG. 3 is a block diagram of the automobile camera system.

FIG. 4 is an exemplary transmitted e-mail message with captured video data.

FIG. 5 is a perspective view of the automobile camera system configured with a satellite link for image retrieval and vehicle surveillance.

Similar reference characters denote corresponding features consistently throughout the attached drawings.

### DETAILED DESCRIPTION OF THE PREFERRED EMBODIMENTS

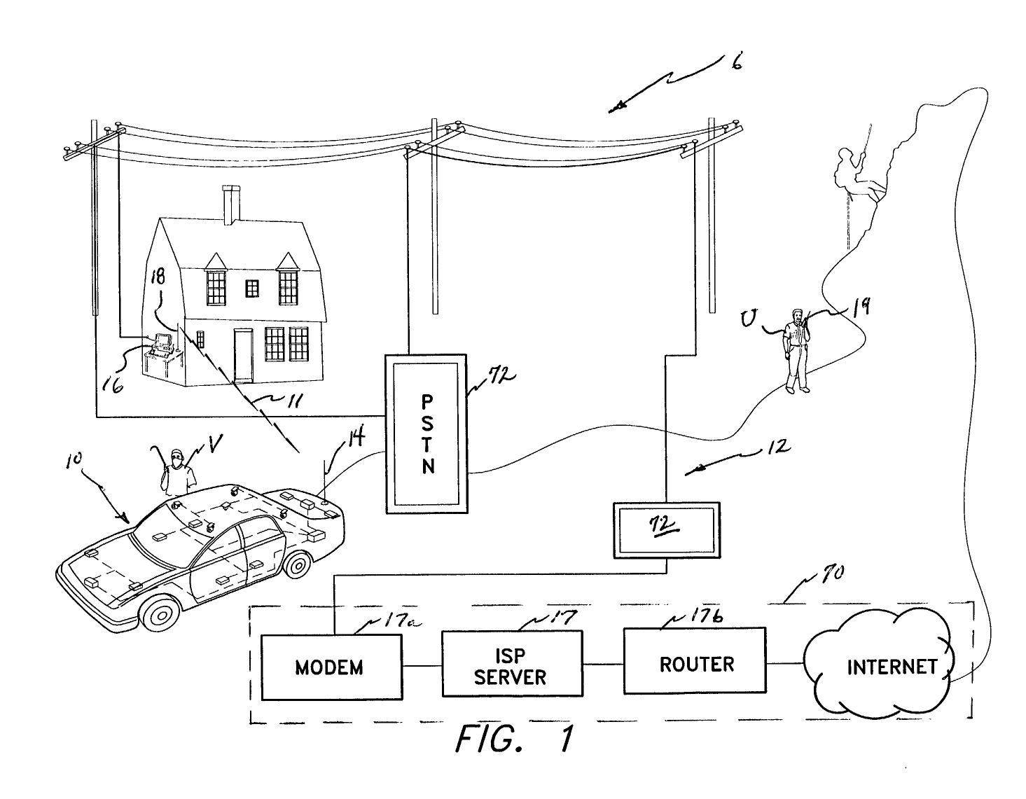

The present invention is directed to an automobile camera system for positively identifying intruders or vandals V in and around automobiles in particular, but the system can be used in residential homes, commercial buildings and the like. The preferred embodiments of the present invention are depicted in FIGS. 1-5, and are generally referenced by numerals 6 and 7, respectively.

As best seen in FIG. 1, the automobile camera system 6 is shown adapted for a vehicle 10, and which provides wireless data transmissions 11 to a computer network system 12 via transmitter 14. The computer network system 12 utilizes at least one lap-top or desk top computer 16, a server 17 and associated modem 17a and router 17b connections through which an Internet Service Provider (ISP) connection is made for internet data access. The ISP connection not only includes local access via a home based computer 16, but also includes Internet access by a remote owner or user U via a variety of remote digital devices 19 such as web-enabled palm digital assistants (PDAs) or pocket PCs. Numerous web-enabled PDAs are commercially available for use with the automobile camera system according to the first embodiment 6. Examples of PDAs include the RIM 957 Blackberry Wireless Handheld, Palm VIIx, HP Jornada 547, Compaq iPAQ, Cassiopeia E-125, Casio EM-500, and the Palm m505. The Palm m505 model, in particular, includes expandable and Internet capable brilliant color for viewing captured images.

The advanced LCD screen delivers more than 65,000 colors for viewing. With the Palm VIIx model, the user U need only raise the antenna of the PDA to connect to an appropriate Internet service and access e-mail. The computer 16 is preferably a Pentium (I, II, III, IV) class processor which includes processor rates up to 1.4 Ghz or higher. The computer 16 includes a receiver or transceiver module 18 electrically adapted thereto for receiving wireless transmission data 11 from at least one, and preferably a number of cameras 22, 24, 26, 28 and 30, for capturing images of an intruder V within a field of view in and around the vehicle 10. The cameras are configured to provide coverage within and around the vehicle 10 within a field of view between 0 and 360 degrees.

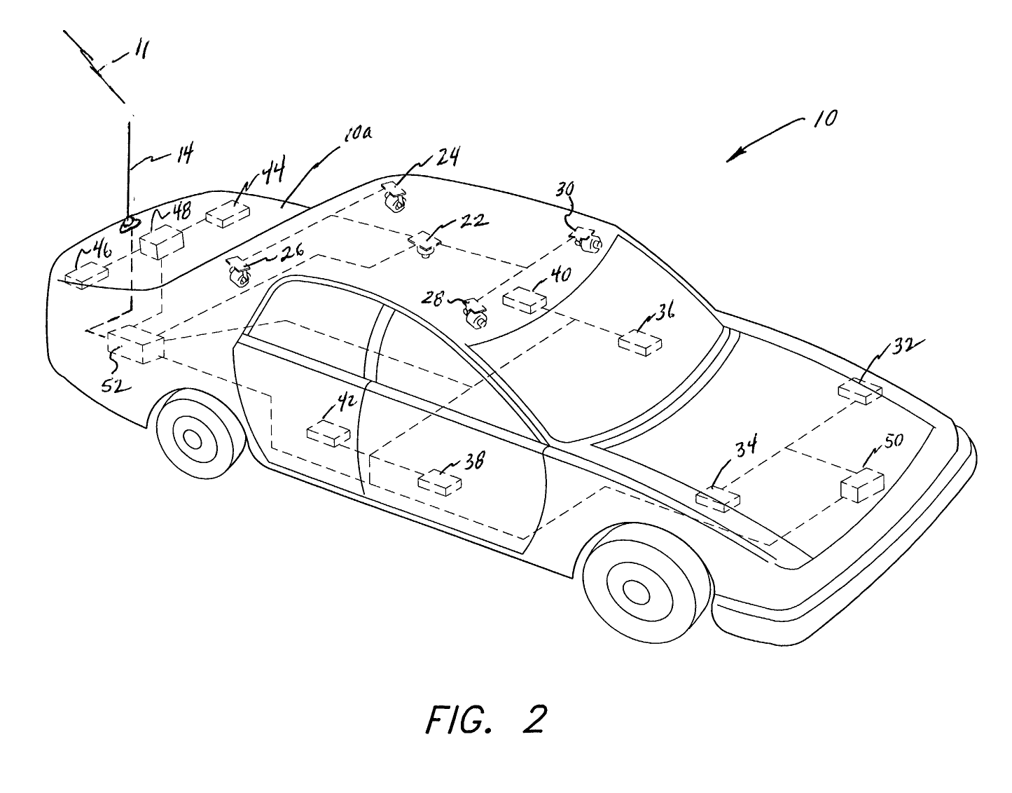

As diagrammatically illustrated in FIG. 2, the vehicle 10 is shown with an exemplary embodiment of a way in which the cameras 22, 24, 26, 28 and 30 can be configured within a vehicle 10 to capture video images of an intruder. As shown therein, the vehicle 10 includes one or more sensors 32, 34, 36, 38, 40, 42, 44 and 46 for detecting an activity (i.e. intruder motion or vehicle impact) within the selected field of view of one or more of the cameras 22, 24, 26, 28 and 30. An optional feature includes a GPS receiver 48 for vehicle tracking or surveillance.

The images captured through each camera are multiplexed and processed as serial image, output data 11 for wireless transmission to a home based computer system 16. The sensors 32, 34, 36, 38, 40, 42, 44 and 46 are electrically configured to capturing means or cameras 22, 24, 26, 28 and 30 such that when one or more of the sensors 32,34,36,38,40,42,44,46 detect activity in the form of motion and/or force vibrations perpetrated by an intruder V on the body of the vehicle 10, one or more of the cameras 22,24,26,28,30 are automatically activated for obtaining images of a respective intruder V within its field of view. There are numerous miniature cameras commercially available; however, the preferred cameras 22,24,26,28,30 used within the vehicle 10 are a digital webcams each having a fish eye lens. The XCAM2 WideEye is a type of webcam that can be used for capturing color video images within a wide field of view or angle of 120 degrees per camera. Thus, according to the preferred embodiment, a series of five cameras are used to provide a field of view around the vehicle 10 which amounts to 5 times the field of view of a single webcam due to the selective placement of each webcam 22,24,26,28 and 30 within the vehicle 10.

The power source 50 of the vehicles is adapted for supplying power to the network of cameras 22,24,26,28,30 and sensors 32,34,36,38,40,42,44,46. Each sensor 32,34,36,38,40,42,44,46 can be synchronized to activate a single camera or a plurality of cameras in a selective sequence depending on the sequence or location of a detected event within the body of the vehicle 10. A cpu or processing means 52 is mounted within covered area or trunk portion 10a of the vehicle for serially processing captured image data 11 of the sensed activity. The processor 52 has a transmission means 14 for transmitting the captured data 11 to a remote device 16 (there may be more than one). According to this configuration, the processor 52, webcams 22,24,26,28,30, sensors 32,34,36,38,40,42,44, 46 and the power source or battery 50 are electrically configured as a single integrated system. A keyless remote (not shown) can be used to activate and deactivate the camera system within a predetermined activation range.

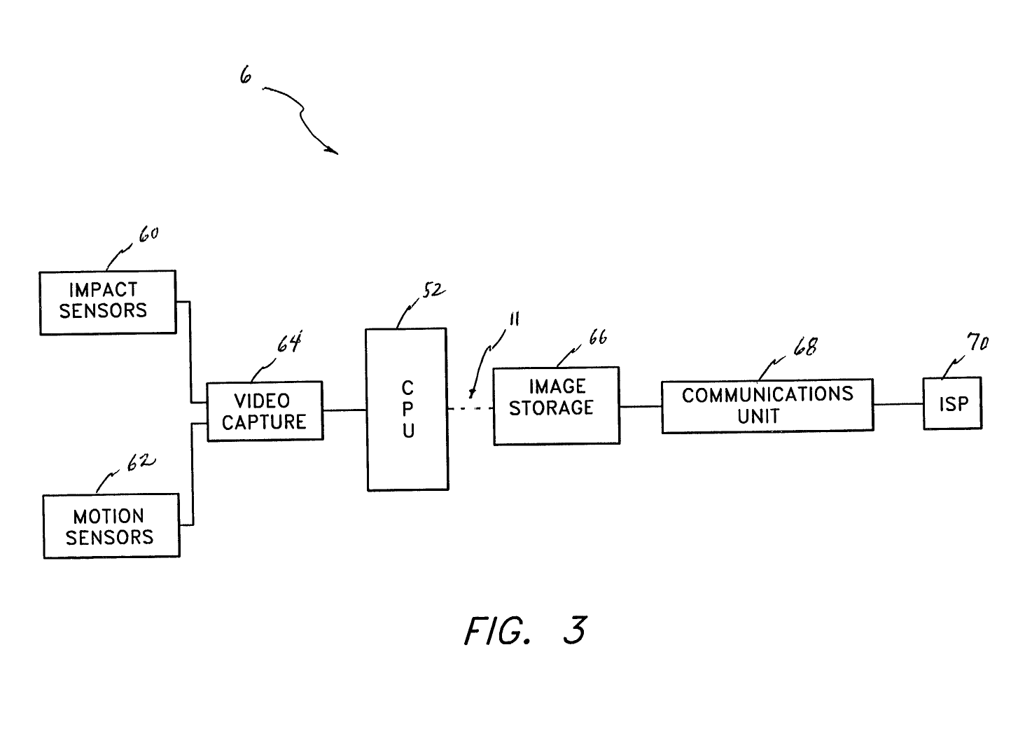

As diagrammatically illustrated in FIG. 3, the automobile camera system 6 comprises an impact sensor module 60, a motion sensor module 62 and a video capture module 64 on the input side of the processor or cpu 52. On the output side is the image storage/retriever module 66 and communications module 68 tied to an ISP module 70 (via a PSTN connection) for internet data transmissions. Module 66 receives wireless transmitted data 11 of captured video images of an intruder V within and/or around the vehicle 10. The intruder image (and optional audio) data captured by the respective digital webcams is received by the computer 16 (via a transceiver) for synchronous software capture via any commercially available e-mail software package such as XRAY VISION software, which is well suited for automatic transmission of received captured images (in the form of an e-mail message) to remote sites virtually anywhere in the world.

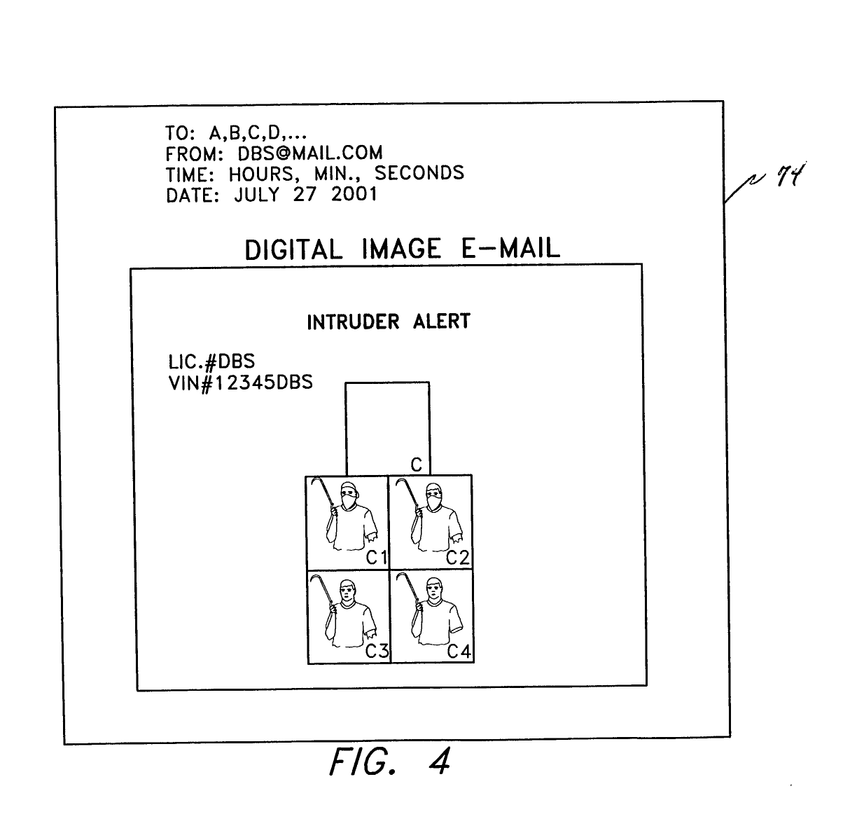

Accordingly, each remote site is identified by a predetermined e-mail addresses or alias A, B, C, D, . . . etc. which include image (and optional audio) data 11. The e-mail addresses A, B, C, D, . . . etc. are pre-set to addresses of local police representatives (eg. police@mail.com, etc.), insurance agencies, or a host of other important contacts which may have need of the information. An exemplary e-mail message 74 is illustrated in FIG. 4. The message heading is set forth with the following sub-sections:

TO: A, B, C, D, . . .

FROM: DBS@MAIL.COM, and

TIME: HOURS, MIN., SECONDS.

An exemplary heading for the image window is indicated as “DIGITAL IMAGE E-MAIL”, but can be customized as a pre-set feature according to personal preference. The transmitted data 11 from each vehicle can automatically include vehicle identification information such as the license plate number (LIC.# DBS) and/or the vehicle identification number (VIN) (VIN#12345DBS), etc. The captured images are preferably displayed according to the selective position of each respective camera 22, 24, 26, 28 and 30. As shown in the body of the e-mail message 74, C represents images taken from an interior camera 22; C1 and C2 represent images capture by rear cameras 24,26; and C3 and C4 represent images captured by cameras 28,30 positioned to capture data in the front of the vehicle 10. With a keyless entry remote controller (not shown), the automobile camera system 6 can be activated and deactivated as needed.

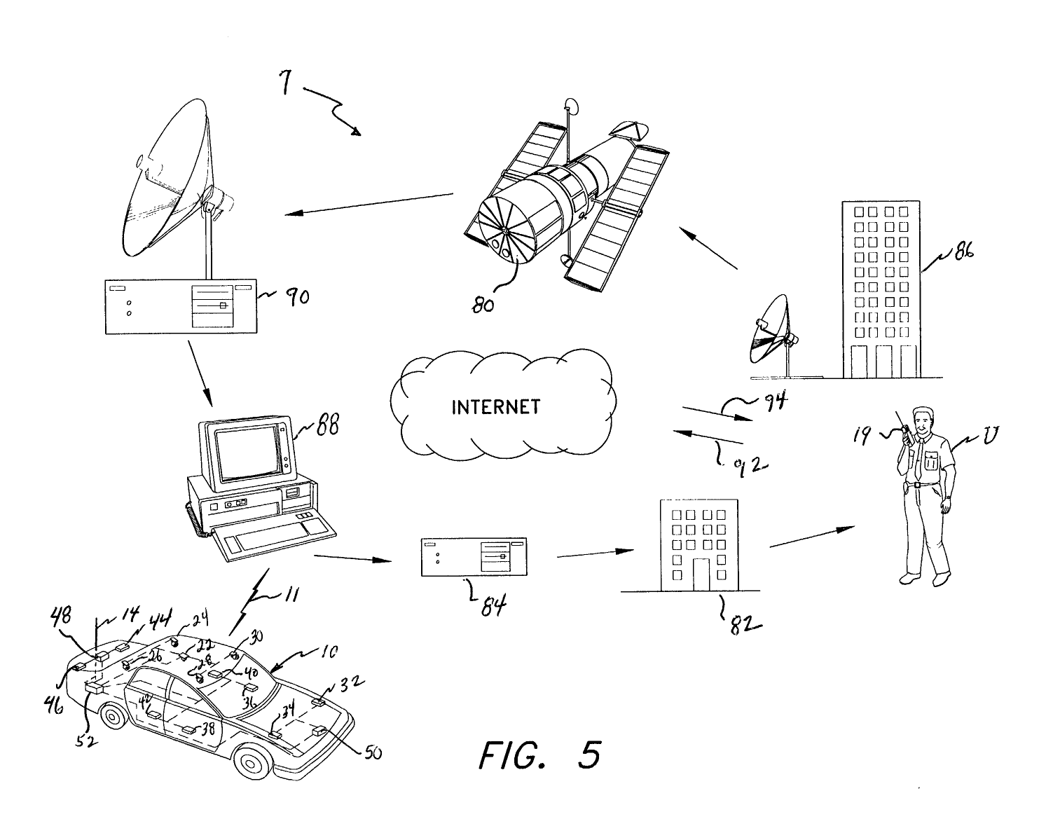

As diagrammatically illustrated in FIG. 5, the automobile system 7 is shown according to a second embodiment to include vehicle tracking or surveillance. The automobile camera system 7, includes the utilization of at least one satellite for data communication and/or vehicle 10 surveillance. As in the first embodiment 6, all the previously recited features are operable, except that Global Positioning Satellite surveillance (illustrated by a satellite 80) is made available via the GPS receiver or transceiver module 48 which links sensed intruder activity V via sensors 44 and 46 with webcam 22, 24, 26, 28 and 30 activation. This provides not only tracking but also image data up-linking via satellite as well.

With respect to image data up-linking, the user U connects to a local ISP 82 through a modem connection 84, but in this case the ISP is responsible for routing the image data through a satellite up-link or Network Operations Center (Direct PC) 86 and for transmitting the image data 11 to a receiver card and into a computer 88 via a satellite modem 90. Once the captured data is made accessible via the Internet, the ISP 82 can request 92 and retrieve 94 the pertinent image data for subsequent up-link and transmission to a remote computer system 88. In either embodiment 6,7 the automobile camera system supplies captured image data 11 which provides authorities local and abroad sufficient information to identify and subsequently apprehend the appropriate suspects. The up-link satellite feature is well known as Direct Broadcast Satellite transmissions.

While this method of data communications operates at in Ku band, which is the group of frequencies from 12 GHz to 18 GHz, Internet access is provided through DirecPC, a product that uses DirecTV technology in conjunction with a PC in order to deliver high-bandwidth, satellite-based access to the internet. The DirecPC package includes a satellite dish and an expansion card that is designed for a PC's I/O bus. This receiver card transmits data from the internet to the computer at 400 Kbps-a rate that is 14 times faster than that of a 28.8 Kbps modem connection. Further, the DBS systems use the MPEG-2 compression scheme because it delivers a clean, high resolution video signal and CD quality sound. The up-link center 86 stores all data in digitized format. It should be noted that the original captured image data is transmitted and received within a data frequency range of around 1 GHz. up to 2.4 GHz. With the utilization of DBS the data transmission rate significantly improves, almost by a 10 fold factor.

It is to be understood that the present invention is not limited to the embodiments described above, but encompasses any and all embodiments within the scope of the following claims.

I claim:

1. An automobile camera system for identifying intruders for automobile theft and vandalism comprising:
at least one means for capturing images within a selected field of view;
at least one sensor for detecting an activity of an intruder within said selected field of view of at least one of said at least one image capturing means;
said sensor being electrically configured to said capturing means such that when the sensor detects activity of an intruder, said capturing means is activated for obtaining images of the intruder;
a power means for supplying power to said capturing means and said sensor means; and
a processing means for processing a captured image data of the sensed activity, said processing means further comprising a transmission means for transmitting captured data to a remote device, said processing means, said capturing means, said sensor and said power means being electrically configured as an integrated camera system.

2. The automobile camera system according to claim 1, wherein said remote device is a computer network system.

3. The automobile camera system according to claim 2, wherein said computer network system includes at least one internet server.

4. The automobile camera system according to claim 3, wherein said computer network system includes at least one digital device, and wireless data transmission and reception via said digital device.

5. The automobile camera system according to claim 4, wherein said digital device is a web-enabled PDA.

6. The automobile camera system according to claim 4, wherein said digital device is a satellite for data communication.

7. An automobile camera system for identifying intruders comprising, in combination with a vehicle having first, second and third housing portions:
at least one means for capturing image and audio data within a selected field of view;
a plurality of sensors for detecting the activity of an intruder within the selected field of said data capturing means; said sensors being electrically configured to said capturing means such that when at least one of the sensors detect activity of an intruder said capturing means is activated for obtaining images of said at least one intruder;
a power means for supplying power to said at least one capturing means and said at least one sensor means;
a processing means for processing said captured data of the sensed activity, said processing means further comprising a transmission means for transmitting captured data to a remote device;
said at least one capturing means being housed within a first housing portion of the vehicle; and
said plurality of sensors being housed within a second and third housing portion of the vehicle.

8. The automobile camera system according to claim 7, wherein said processing and transmission means are housed within said second housing portion of the vehicle.

9. The automobile camera system according to claim 7, wherein said power means being housed within said third housing portion of the vehicle.

10. The automobile camera system according to claim 7, wherein said first housing portion is an interior cab portion of the vehicle.

11. The automobile camera system according to claim 7, wherein said second housing portion is an interior trunk portion of the vehicle.

12. The automobile camera system according to claim 7, wherein said third housing portion is an interior hood portion off the vehicle.

13. The automobile camera system according to claim 7, wherein said remote device is a computer network system.

14. The automobile camera system according to claim 13, wherein said computer network system includes at least one Internet server.

15. The automobile camera system according to claim 13, wherein said computer network system includes a digital device, and wireless data transmission and reception via at said digital device.

16. The automobile camera system according to claim 15, wherein said digital device is a web-enabled PDA.

17. The automobile camera system according to claim 15, wherein said digital device is a satellite for data communication.

18. The automobile camera system according to claim 17, wherein said data is positional data of the automobile.

19. The automobile camera system according to claim 7, wherein said system is configured to transmit and receive original captured data at a frequency range of from around 1 GHz. up to 2.4 GHz.

20. An automobile camera system for identifying intruders comprising:
at least one means for capturing images within a selected field of view at an original frequency range of around 1 GHz up to 2.4 GHz;
at least one sensor for detecting an activity of an intruder within said selected field of view of said image capturing means;
said sensor being electrically configured to said image capturing means such that when said sensor detects activity of an intruder, said capturing means is activated for obtaining images of the intruder;
a power means for supplying power to said image capturing means and said sensor means;
a processing means for processing said captured image data of the sensed activity, said processing means further comprising a transmission means for transmitting captured data to a remote device, said processing means, said image capturing means, said sensor and said power means being electrically configured as a single integrated camera system; and
wherein said system transmits and receive captured image data within a frequency range of around 12 GHz. up to 18 GHz.
